(19) United States
(12) Patent Application Publication
(10) Pub. No.: US 2018/0039763 A1
(43) Pub. Date: Feb. 8, 2018

(54) ARTIFICIAL INTELLIGENCE SYSTEM FOR USE IN CONDUCTING CLINICAL TRIALS

(71) Applicant: Peach IntelliHealth, Inc., New York, NY (US)

(72) Inventor: Bruce Tidor, Lexington, MA (US)

(21) Appl. No.: 15/784,537

(22) Filed: Oct. 16, 2017

Related U.S. Application Data
(63) Continuation of application No. 14/219,379, filed on Mar. 19, 2014, now abandoned.

(51) Int. Cl. G06F 19/00

(52) U.S. Cl. CPC G06F 19/363

(57) ABSTRACT

A computer-based method includes receiving health-related data at a computer-based processing system, via a network, wherein the health-related data is associated with each respective one of a plurality of individuals participating in a clinical trial. An artificial intelligence-based evaluation of each of the patients is applied, based on the health-related data, to identify patients for whom participation in the clinical trial should be altered. A notification is generated that, when rendered at a computer-based user interface device, reveals the identified information. Feedback is received at the computer-based processing system, via the network, that corresponds to the generated notification, after the clinical trial participation is altered, the artificial intelligence-based evaluation is altered at the computer-based processing system in view of the feedback received to improve the computer-based processing system's ability to accurately identify patients for whom participation in the clinical trial should be altered.

### CROSS REFERENCE TO RELATED APPLICATIONS

This application is a continuation of, and claims priority to, U.S. patent application Ser. No. 14/219,379, entitled “Managing Allocation of Health-Related Expertise and Resources” and filed on Mar. 19, 2014, the entirety of which is incorporated herein by reference.

### FIELD OF THE INVENTION

This disclosure relates to the evaluation of patients participating in clinical trials using artificial intelligence.

### BACKGROUND

In recent years, the financial resources and medical expertise needed to provide medical care and conduct medical research have become extremely scarce. There is, nevertheless, a continuous demand for these types of activities. There is a need, therefore, to facilitate efficient and effective allocation of these kinds of resources to provide medical care and conduct medical research.

### SUMMARY OF THE INVENTION

In one aspect, a computer-based method includes receiving health-related data associated with each respective one of multiple individuals, all of whom have, had, or will likely have the same health-related experience. An algorithm is applied to identify, based on the health-related data, information relevant to facilitate efficient allocation of medical expertise or resources to the health-related experience of one or more of the individuals. A notification is generated that, when rendered at a computer-based user interface device, reveals the identified information. Feedback is received that corresponds to the generated notification, after the medical expertise or resources have been allocated to the health-related experience in response to the generated notification. The algorithm is then evaluated and possibly adjusted in view of the feedback received to improve the computer-based processing system's ability to accurately identify the information relevant to facilitate efficient allocation of medical expertise or resources.

In other aspects, a computer-based system to perform and/or facilitate the method and a non-transitory, computer-readable medium that stores instructions that when executed by a computer-based processor causes the computer-based processor to perform and/or facilitate the method are disclosed.

The efficiencies and effectiveness facilitated by the techniques and systems described herein provide significant benefits in terms of financial savings as well as savings in time and effort.

In some implementations, one or more of the following advantages are present.

For example, systems and methods are disclosed to provide information relevant to facilitating the efficient and effective allocation of additional resources (e.g., to provide follow-up medical tests, screening, examination, or treatment to certain individuals or to adjust certain operational parameters of a clinical trial) in connection with the health-related experiences of a group of individuals.

Moreover, the systems and methods are able to iteratively evolve and improve over time so that the ability to identify information relevant to facilitate efficient allocation of medical expertise or resources potentially improves. In a typical implementation, the improvements occur automatically in response to feedback provided by the individuals and other system users.

Additionally, the systems and methods are able to compare different treatment regimens applied to different individuals and can identify medical personnel or practices that produce more advantageous outcomes in terms of treatment success, amelioration of symptoms, or cost. The system and methods can be used to compare outcomes on different wards or between different hospitals to identify practices implicated in more favorable or less favorable outcomes.

Other features and advantages will be apparent from the description and drawings, and front the claims.

### BRIEF DESCRIPTION OF THE DRAWINGS

FIG. 1 is a schematic diagram of an exemplary computer system that is adapted to facilitate the efficient and effective allocation of resources in various applications within the health-care industry.

FIG. 2 is a schematic diagram showing an exemplary implementation of the computer-based processing system in FIG. 1, which is adapted to perform functionalities to support the performance of the exemplary computer system in FIG. 1.

FIG. 3 is a flowchart showing an exemplary process performed by the computer-based processing system in FIG. 1.

FIGS. 4A-4C are schematic diagrams of exemplary computer-based user-interface devices with notifications on their screens generated by the computer-based processing device.

FIGS. 5A-5F show a series of screenshots from an exemplary implementation at one of the computer-based user interface devices.

In the drawings, like reference numbers refer to like elements.

### DETAILED DESCRIPTION

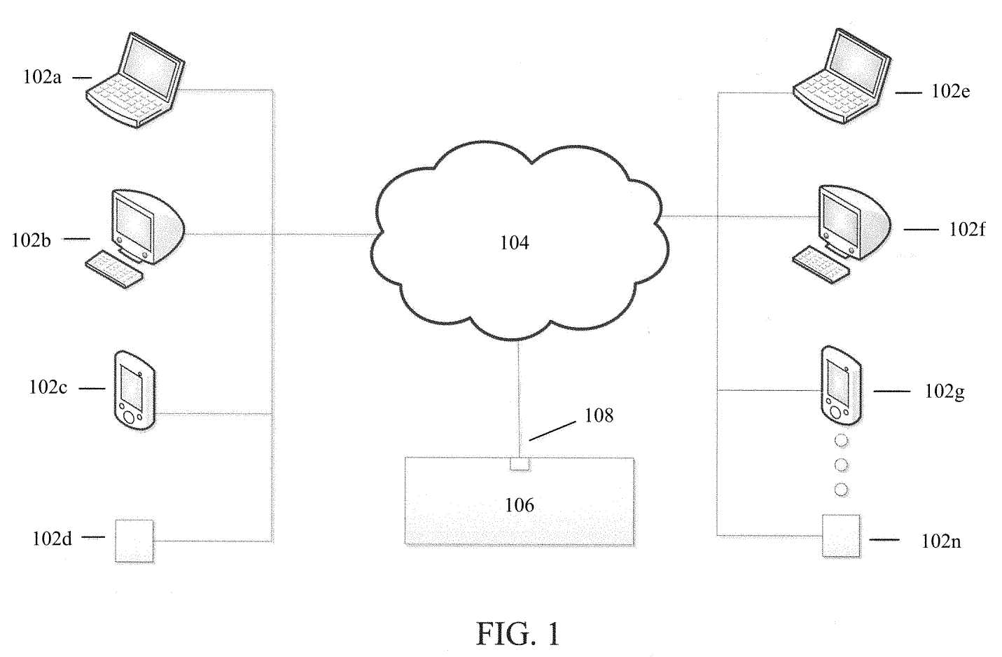

FIG. 1 is a schematic diagram of an exemplary computer system 100 adapted to facilitate efficient management of resources in various applications in the health-care industry.

The illustrated system 100 includes computer-based user interface devices 102a-102n that are coupled, via a communications network 104 (e.g., the Internet), to a computer-based processing system 106. Much of the system 100 functionality described herein is performed or facilitated by the computer-based processing system 106.

In general, the computer-based processing system 106 is operable to monitor, over time, health-related data of a potentially large number of individuals who may have experienced or are experiencing the same particular health-related experience (e.g., they all have been treated for myocardial infarction, or they all are participating as a subjects in a clinical trial for a new drug to treat diabetes) and to identify, based on the health-related data, information relevant to facilitate the efficient and effective allocation of additional resources (e.g., to provide follow-up medical treatment to certain individuals or to adjust certain operational parameters of the clinical trial) in connection with the health-related experience.

The computer-based processing system 106 can use any one of a wide variety of specific techniques to identify, based on the health-related data, information relevant to facilitate the efficient and effective allocation of additional resources. Some of these techniques include, for example, Maximum Information Spanning Trees (MIST) for dimension reduction of biological data sets or computational modeling involving a mathematical framework that takes a set of input data regarding an individual and produces an expectation of what future data should look like. Other examples include artificial neural networks (ANNs), support vector machines (SVMs), and genetic algorithms (GAs). A comparison of expectation to actual future data can lead to improved algorithms; those algorithms can identify individuals that likely need further follow up or who are at risk for specific issues, such as medical problems.

Additionally, the computer-based processing system 106 iteratively modifies the algorithm it uses to identify the information regarding resource allocation. Typically, the computer-based processing system 106 does this automatically (i.e., without requiring specific involvement from a human) in response to certain types of feedback that the computer-based processing system 106 receives (e.g., from one of the individuals or one of their medical care practitioners or family members via one of the computer-based user interface devices 102a-102n) about a previous piece of information relevant to efficient and effective resource allocation that the computer-based processing system 106 identified.

Thus, the computer-based processing system 106, by adjusting the algorithm, is able to evolve and improve over time, iteratively and automatically, in response to feedback. There is a wide array of techniques that the computer-based processing system 106 can utilize to adjust the algorithm; some of these implicate machine learning, artificial intelligence and/or various other computational techniques.

One example of how the system 100 might be used to facilitate the efficient management of resources in an application in the health-care industry relates to clinical trials. In general, a clinical trial is a prospective biomedical or behavioral research study on human subjects that is designed to answer specific questions about nutritional, biomedical, or behavioral interventions (novel vaccines, drugs, treatments, devices or new ways of using known interventions), generating safety and efficacy data.

A company, knowing, for example, that a new Alzheimer's drug they have developed will only work on a subset of the population might undertake a clinical trial to try to determine how to identify which patients (or types of patients) will respond positively to the new drug or experience positive or negative side effects, including adverse events. In that example, each trial participant, whether in a placebo or the treatment group, might begin the trial with a genome analysis and blood chemistry test; with the blood chemistry test being repeated every month during the clinical trial. Because the company does not know which patients will respond positively to the new drug or what fraction of the population will respond positively, the company may be concerned that the trial will not be large enough to show statistical significance. If the company needs to wait until the end of the trial only to learn that it has not worked, the company would essentially lose its investment in the original clinical trial.

The system 100 can be used to facilitate the efficient and effective allocation of resources to manage the clinical trial so as to reduce the possibility of losing the company's investment in the clinical trial.

In this regard, the system 100 can monitor all of the data collected during the trial. All of the genetic data and blood chemistry test data can be transmitted from the medical record of each individual clinical trial subjects to the computer-based processing system 106. The clinical trial subjects may be asked to use a computer-based application (e.g., executing on a smartphone) that reminds each subject when to take each dose and asks each subject to confirm when they actually take each dose. Additional personal monitoring data can be collected through a computer-based application. All of these data, too, can be transmitted to the computer-based processing system 106.

The computer-based processing system 106 monitors and processes the data it receives to identify information that is relevant to facilitate the efficient and effective allocation of additional resources (e.g., to adjust certain operational parameters of the clinical trial) in connection with the clinical trial. For example, the computer-based processing system 106 may be able to identify, relatively early on in the trial, a subset of patients who likely are strong responders, and to identify a combination of genetic and blood chemistry biomarkers for those patients. Additionally, the computer-based processing system 106 may be able to identify (e.g., based on the blood chemistry test data or feedback provided by the patients, their healthcare providers or caregivers) any patients who are likely not complying with operational parameters associated with the clinical trial or who are experiencing negative or adverse reactions.

A clinical trial example: Patients are able to enter (e.g., via the computer-based user interface device) their feedback, including negative, positive or unusual side effects. For example, a subset of patients may experience new hair growth in previously bald spots, and the system is able to generate a signal to the trial provider who might not have guessed at the possibility of new hair growth, and the system can evolve to look for additional patients that have experienced this phenomenon, or the system can start collating patient specifics that could contribute to new hair growth. Another example is when a subset of patients inputs feedback that the drug refilled this month has a sweet smell. In this case, the system processes, analyzes and alerts the drug company. The drug company can investigate the batch of drugs, recall them if needed, change drug storage procedures, or it may equate the increased scent perception as a novel biomarker of its drug's efficacy in Alzheimer's, which the system will use to evolve how it prompts patients for specific data and/or relates new data to existing data.

In a typical implementation, any information identified by the computer-based processing system 106 in connection with a clinical trial would be provided to the company (e.g., a human trial monitor that works for the company) in an electronic notification that maintains patient confidentiality and the blind or double-blind nature of the clinical trial.

The company, in response to receiving an electronic notification regarding the information identified by the computer-based processing system 106 can, if it so desires, allocate resources to specific aspects of the clinical trial related to the notification. If, for example, the notification indicates that certain subjects are likely not complying, the company may allocate resources to confirm that those subjects are not complying and see if they will agree to comply subsequently. Alternatively, the company may allocate resources to terminate the participation of the subjects who are likely not complying from the clinical trial.

If, for example, the company, in following-up, determines that the system 100 incorrectly identified one or more of the clinical trial subjects as being non-compliant (i.e., the company determines that the identified subject actually has been compliant), the company can provide feedback to the system 100 (via one of the user-interface devices 102a-102n) that the identified subject was compliant.

If the computer-based processing system 106 receives this kind of feedback, it considers adjusting the algorithm that it used to identify (or classify) the clinical trial participant as being likely incompliant. In considering whether to adjust the algorithm, the computer-based processing system 106 may take into consideration one or more of the following: the algorithm itself, the specific error identified in the feedback provided, the underlying health-related data that the incorrect identification was based upon, and data and classifications made by the system 106 for other individuals who are participating in the clinical trial.

If, in view of the foregoing considerations, the computer-based processing system 106 determines that the algorithm in question should be adjusted, then the adjustment is made and the adjusted algorithm is used for any subsequent processing the computer-based processing system 106 to determine whether any of the individuals in the clinical trial is likely being compliant with the clinical trial requirements.

Referring again to the system 100 in FIG. 1, in general, any data is input to the system 100 and output from the system 100 via one or more of the computer-based user-interface devices 102a-102n.

The computer-based user interface devices 102a-102n can be virtually any type of computer-based device that is able to communicate (e.g., over the communications network 104) with the computer-based processing system 106. Some of the computer-based user interface device 102a-102n can include data input devices (e.g., keyboard, touchscreen, a computer mouse, a microphone, etc.) and some can include data output devices (e.g., a computer screen, a speaker, etc.). Others can include personal monitoring devices such as heart monitors, blood glucose monitors, temperature monitors, etc. In general, the data input devices enable the various parties (e.g., clinical trial subjects, myocardial infarction patients, etc.) to enter information into the system and the output devices enable the various parties (e.g., clinical trial managers, licensed medical practitioners, etc.) to access generated notifications. The generated notifications can include, for example, accumulated data, the results of machine learning or artificial intelligence analysis of the data, and processed summaries of data, such as summary tables or the like, etc.

The specific computer-based user interface devices 102a-102n shown in the illustrated implementation include laptop computers 102a, 102e, desktop computers 102b, 102f, handheld computer devices 102c, 102g and other computer-based health-monitoring devices 102d, 102n (e.g., activity trackers, such as the Fitbit® Wireless Activity Tracker or the like). The computer-based processing system 106 can be any computer-based device or combination of devices that is operable to provide functionality to support system 100 operations as described herein.

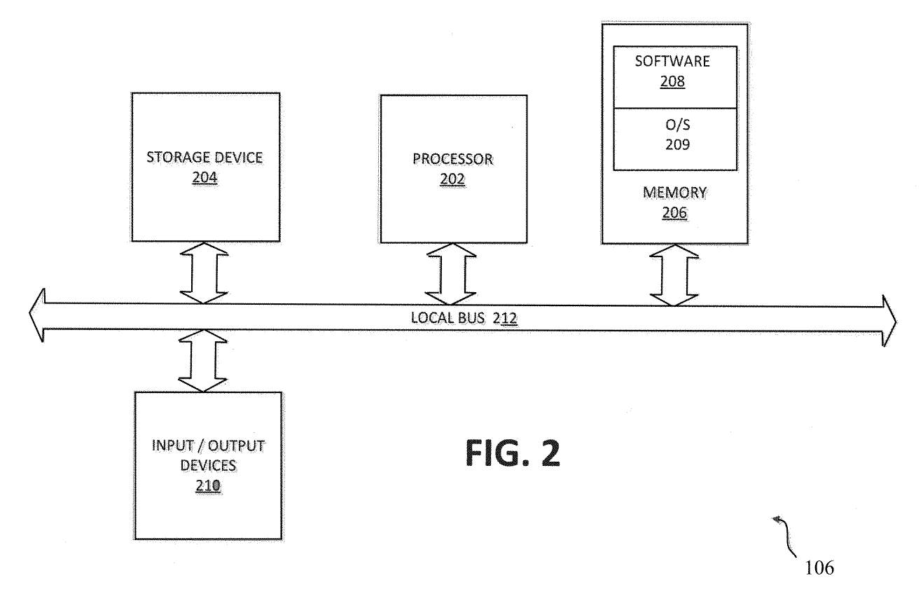

FIG. 2 is a schematic diagram showing an exemplary implementation of the computer-based processing device 106 in FIG. 1.

The illustrated computer-based processing device 106 has a computer-based processor 202, a computer-based storage device 204, a computer-based memory 206 with software 208 stored therein that, when executed by the processor 202, causes the processor to provide functionality to support system 100 operations as described herein, input and output (I/O) devices 210 (or peripherals), and a local bus, or local interface 212 that allows for internal communication within the computer-based processing device 106. The local interface 212 can be, for example, one or more buses or other wired or wireless connections. In various implementations, the computer-based processing device 106 may have additional elements, such as controllers, buffers (caches), drivers, repeaters, and receivers, to facilitate communications and other functionalities. Further, the local interface 212 may include address, control, and/or data connections to enable appropriate communications among the illustrated components.

The processor 202, in the illustrated example, is a hardware device for executing software, particularly that stored in the memory 206. The processor 202 can be any custom made or commercially available single core or multi-core processor, a central processing unit (CPU), an auxiliary processor among several processors associated with the present server 102, a semiconductor based microprocessor (in the form of a microchip or chip set), a microprocessor, or generally any device for executing software instructions. In addition, the processing function can reside in a cloud-based service accessed over the internet.

The memory 206 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 206 may incorporate electronic, magnetic, optical, and/or other types of storage media. The memory 206 can have a distributed architecture, with various memory components being situated remotely from one another, but accessible by the processor 202.

The software 208 includes one or more computer programs, each of which contains an ordered listing of executable instructions for implementing logical functions associated with the computer-based processing system 106, as described herein. The memory 206 may contain an operating system (0/S) 520 that controls the execution of one or more programs within the computer-based processing system 106, including scheduling, input-output control, file and data management, memory management, communication control and related services and functionality.

The I/O devices 210 may include one or more of any type of input or output device. Examples include a keyboard, mouse, scanner, microphone, printer, display, etc. In some implementations, a person having administrative privileges, for example, may access the computer-based processing device to perform administrative functions through one or more of the I/O devices 210.

In a typical implementation, the computer-based processing device 106 also includes a network interface 108 (not shown in FIG. 2, but see FIG. 1) that facilitates communication with one or more external components via the communications network 104. The network interface 108 can be virtually any kind of computer-based interface device. In some instances, for example, the network interface 108 may include one or more modulator/demodulators modems); for accessing another device, system, or network), a radio frequency (RF) or other transceiver, a telephonic interface, a bridge, a router, or other device. During system operation, the computer-based processing device 106 receives data and sends notifications and other data via the network interface 108. In some embodiments, the entire system will have the privacy, security, and other features required to be HIPAA compliant.

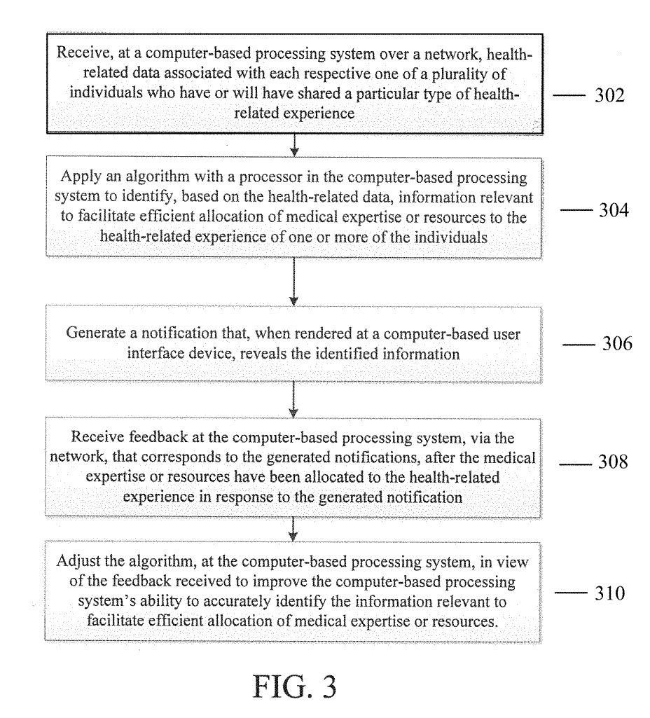

FIG. 3 is a flowchart showing an example of the processes that can be performed by the computer-based processing system 106 in FIG. 1 to support the system functionalities described herein.

According to the illustrated method, the computer-based processing system 106 receives (at 302) health-related data associated with each respective individual in a group of individuals, all of whom have, had, or will likely have the same particular health-related experience. The health-related experience can be any type of experience that influences, impacts or relates to health. As mentioned above, one such example is participating as a subject in a particular clinical trial (e.g., for a particular drug to treat diabetes). Other examples include being at risk for, having been diagnosed with (or suspected of having) and/or having been treated for some specific illness or ailment (e.g., myocardial infarction, heart valve disease, heart failure, coronary artery disease, cardiac arrhythmia, diabetes, stroke, ischemia, sepsis, kidney disease, liver disease, mental illness, eating disorder, anxiety disorder, psychotic disorder, dementia, addictive behavior, bipolar disorder, depression, manic depression, schizophrenia, schizoaffective disorder, posttraumatic stress disorder, Alzheimer's disease, panic disorder, sleep disorder, sleep disturbance, sleep apnea, insomnia, sleep deprivation, restless legs syndrome, snoring, sleepwalking, REM sleep disorder, sleep paralysis, night sweats, sleep talking, dyssomnia, hypopnea, narcolepsy, nocturnal myoclonus (periodic limb movement disorder), delayed sleep phase disorder, sleep terrors, etc.), executing a particular type of fitness regime, being in or about to enter hospice care, etc.

In one particular example, the health-related experience includes the occurrence of Methicillin-resistant Staphylococcus aureus (MRSA) infections. In that example, hospital users (e.g., staff nurses in the geriatric ward) can input information into the system regarding MRSA infections and current procedures, the system can evaluate the frequency against known baseline, best practices, and perform analytics, then generate a response to the hospital administrator who can implement stricter hand-washing and other antiseptic vigilance, or other procedures. In most instances, the specific type(s) of health-related data that the computer-based processing system 106 receives for a particular group of individuals will depend on the particular type of health-related experience that those individuals share.

If, for example, all of the individuals in the group are participating as subjects in a clinical trial for a new drug to treat diabetes (as the shared health-related experience), then the health-related data that the computer-based processing system 106 receives may include, for example, genome analysis data for each respective individual and data from periodic blood chemistry tests for each respective individual. Of course, the health-related data may include other types of data (e.g., blood pressure, resting heart rate, weight, etc.) as well. As another example, if all of the individuals in the group have experienced congestive heart failure and are at risk for fluid build-up requiring emergency care (as the shared health-related experience), then the health-related data that the computer-based processing system 106 may receive can include, for example, data related to each respective individual's weight, activity, and diet, since these are known (or suspect) factors that may influence fluid build-up in individuals who have experienced congestive heart failure.

The health-related data can come to the computer-based processing device 106, through the network interface 108, from a variety of different sources including, for example, from an electronic database that includes medical records maintained by or on behalf of a licensed medical practitioner associated with one of the individuals, from entries made by or on behalf of one of the individuals in the group (e.g., by a family member, case manager, care giver, friend, etc.) at one of the computer-based user-interface devices, from a computer-based health-monitoring devices (e.g., an activity tracker, such as the Fitbit® Wireless Activity Tracker or the like), from a database associated with a computer application or website that helps users track diet and exercise information to achieve certain goals, such as the MyFitnessPal™ computer application and website. There are other sources of health-related data, including wearable, attachable, and implantable monitoring devices.

Typically, the health-related data is transmitted from a source device (e.g., one of the computer-based user interface devices 102a-102n) to the computer-based processing device 106 over the communications network 104. The communications network 104 can implement any one or more of numerous possible communication technologies including, for example, based on wired transmission, wireless transmission, the Internet (e.g., TCP/IP), Bluetooth™ communication, near-field, infrared, radio waves, etc. In a typical implementation, the computer-based processing device 106 stores the health-related data it receives in a memory storage device (e.g., in 204 or 206 in FIG. 6). In some implementations, one or all of the memory storage devices may be cloud-based memory storage devices.

Referring again to FIG. 3, the illustrated method has the computer-based processing system 106 applying an algorithm (at 304) to identify, based on the received health-related data, information relevant to facilitate efficient allocation of medical expertise or resources to the health-related experience of one or more of the individuals.

The specific algorithm applied can be virtually any type of algorithm that can be applied to the health-related data in order to produce the desired output. In one implementation, for example, the algorithm calculates, based on the health-related data received, how likely each respective individual in a particular group is to possess a particular characteristic (e.g., not complying with a clinical trial requirement). In a typical implementation, each respective piece of data may be weighted differently (i.e., accorded a different degree of influence) in the calculation. Computer algorithms can be used to determine these weights such as through a variety of machine learning and artificial intelligence tools. In some implementations, the calculation involves only health-related data associated with the specific individual under consideration. In other implementations, however, the calculation may take into account health-related data associated with other individuals in the group as well. Next, the algorithm ranks the individuals according to the calculated likelihoods and identifies, based on the rankings, which one or more of the individuals is most likely to possess the characteristic under consideration. In some implementations, the identified individual(s) include any who fall within a specified range in the rankings (e.g., highest, top 3, bottom 4, lowest, etc.). In other embodiments the algorithm identifies individuals with high likelihood of being at significant risk for an adverse outcome or event so that they may be assessed for preventive measures.

In one example, the algorithm is adapted to identify which subject or subjects in a clinical trial are more likely than others to not be complying with one or more performance requirements of the clinical trial. In another example, the algorithm is adapted to identify which subject or subjects in a clinical trial are more likely than others to be showing (or likely to show) negative adverse effects, positive side effects, or efficacy in the clinical trial. In yet another example, the algorithm is adapted to identify which individual or individuals are more likely than others to be susceptible to developing a medical complication (e.g., fluid build-up) related to a medical condition for which the person has been diagnosed (e.g., congestive heart failure).

Each of the foregoing examples illustrates a type of information that is relevant to facilitate efficient allocation of medical expertise or resources to the health-related experience of one or more of the individuals. For example, knowing which subject or subjects in a clinical trial are more likely than others to not be complying with one or more performance requirements of the clinical trial facilitates the efficient allocation of resources to address non-compliance problems in a clinical trial. Likewise, knowing which subject or subjects in a clinical trial are more likely than others to be showing (or likely to show) a positive reaction to the clinical trial facilitates the efficient allocation of resources to derive meaningful conclusions from the clinical trial. Similarly, knowing which individual or individuals are more likely than others to be susceptible to developing a medical complication related to a medical condition the person experienced or has been diagnosed with facilitates the efficient allocation of resources to avoid those complications.

In some implementations, the computer-based processing system 106 applies multiple different algorithms to the same collection of health-related data to identify different types of information relevant to facilitate efficient allocation of medical expertise or resources to the health-related experience of one or more of the individuals.

Next, according to the illustrated method, the computer-based processing system 106 generates a notification that, when rendered at one of the computer-based user interface devices 102a-102n, reveals the identified information or a code signaling the type of information. In a typical implementation, a rendered version of the generated notification may be viewable from the computer-based user interface devices 102a-102n, for example, by accessing a website, receiving an email or a text message or through any other type of message delivery platform.

For some of the generated notifications, the rendered version will only be viewable by certain people. For example, in implementation, the system 100 may be configured to send a particular generated notification to only the specific individual associated with the generated notification. In those implementations, the generated notification may be, “John Doe, please schedule a follow-up visit to your doctor within the next few days,” and that notification may be sent, via text message or email, to only John Doe. According to another example, the system 100 may be configured to send a particular generated notification to a physician or family member or designated care giver, etc. of the specific individual associated with the generated notification. In those implementations, the generated notification may be, “John Doe should schedule a follow-up visit to your doctor within the next few days,” and that notification may be sent, via text message or email, to the target people. In another example, only the party responsible for conducting a clinical trial will be able to view certain generated notifications.

In various implementations, one or more security measures may be provided to ensure confidentiality of the content in a generated notification. The security measures can be any one or more of various possible security measures including, for example, requiring the entry of a password to access a rendered version of the generated notification.

If a generated notification relates to a blind or double-blind clinical trial, the generated notification will maintain the blind or double blind nature thereof.

As discussed herein, once a party (e.g., an individual who is likely developing a health-related complication, a physician for that individual, a party who is responsible for conducting a clinical trial, etc.) receives one of the generated notifications, that party may (or may not) decide to allocate medical expertise or resources (medical or otherwise) in response to the generated notification. The resources can include, for example, time, effort and/or money. If the party does allocate any medical expertise or resources and finds that the indication represented by the generated notification was incorrect for any reason, that party can provide feedback into the system about the generated notification. The feedback may indicate, for example, that the indication was incorrect. Similarly, feedback that the indication was correct can also be entered into the system and used in machine learning and artificial intelligence procedures that aim to improve the algorithm to assess risk, to assist in resource allocation, and other tasks described herein.

There are a number of possible ways that a party might provide this kind of feedback into the system 100. For example, in some implementations, the system 100 can email or text a party to solicit any feedback about a particular generated notification. The email or text could, for example, include a link to a website with a query for the party about the accuracy and usefulness, for example, of the generated notification. The query can take a number of possible forms, but, in a simple form would include one or more true/false or multiple choice questions. Any responses (i.e., feedback) thus provided by the party can be transmitted to the computer-based processing system 106.

The computer-based processing system 106 receives this feedback (at 308 in FIG. 3) through its network interface 108. Each item of feedback corresponds to one of the generated notifications.

If the feedback received indicates that an identification represented by one of the generated notifications was incorrect, then the computer-based processing system 106 adjusts (at 310) the algorithm in view of the feedback received to improve the computer-based processing system's ability to accurately identify the information relevant to facilitate efficient allocation of medical expertise or resources.

There are a variety of ways that the algorithm may be adjusted. Typically, the computer-based processing device 106 adjusts the algorithm taking into consideration not only the feedback to the specific generated notification that the feedback relates to, but also, in some implementations, feedback associated with other generated notifications and/or underlying health-related data that one or more of the generated notifications were based on. In some implementations, adjusting the algorithm implicates machine learning, artificial intelligence and/or other computational techniques.

In some instances, the computer-based processing system 106 will receive additional feedback regarding the algorithm that corresponds to a different one of the generated notifications. In response, the computer-based processing system iteratively (e.g., every time new positive or negative feedback is received) adjusts the algorithm in view of the additional feedback. In general, each iterative adjustment is an attempt to further improve the ability of the computer-based processing system 106 to accurately identify information relevant to facilitate efficient allocation of medical expertise or resources.

In a typical implantation, every time after an algorithm has been adjusted, any earlier versions of that algorithm are abandoned and subsequent processing occurs using the adjusted algorithm. Thus, the computer-based processing system 106, by adjusting the algorithm, is able to evolve and improve over time, iteratively and automatically, in response to feedback. This results in iterative improvements to the computer-based processing system's ability to accurately identify the information relevant to facilitate efficient allocation of medical expertise or resources.

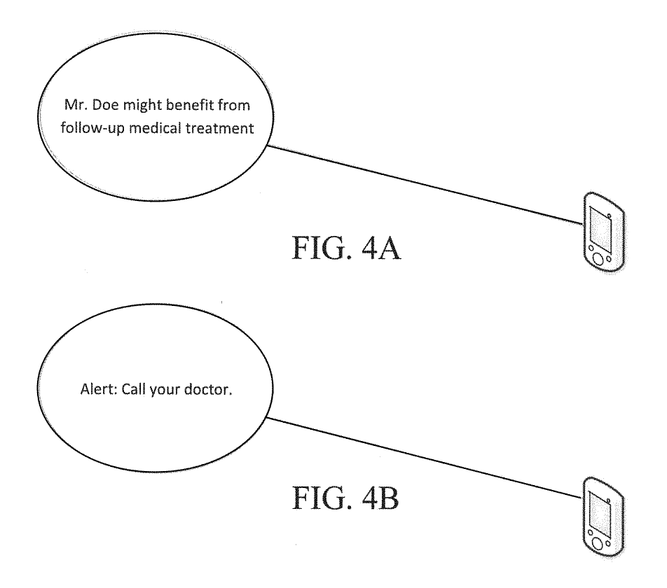

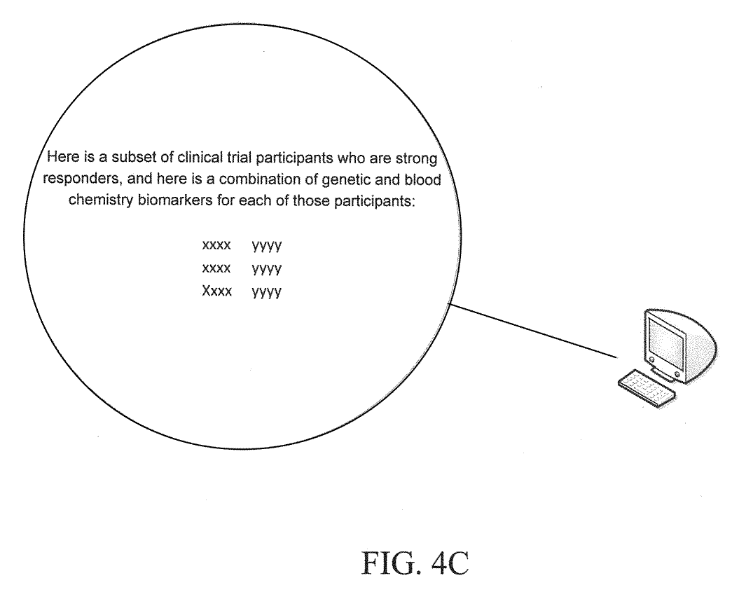

FIGS. 4A-4C show exemplary computer-based user interface devices, each having a rendered version of respective exemplary generated notifications on its screen.

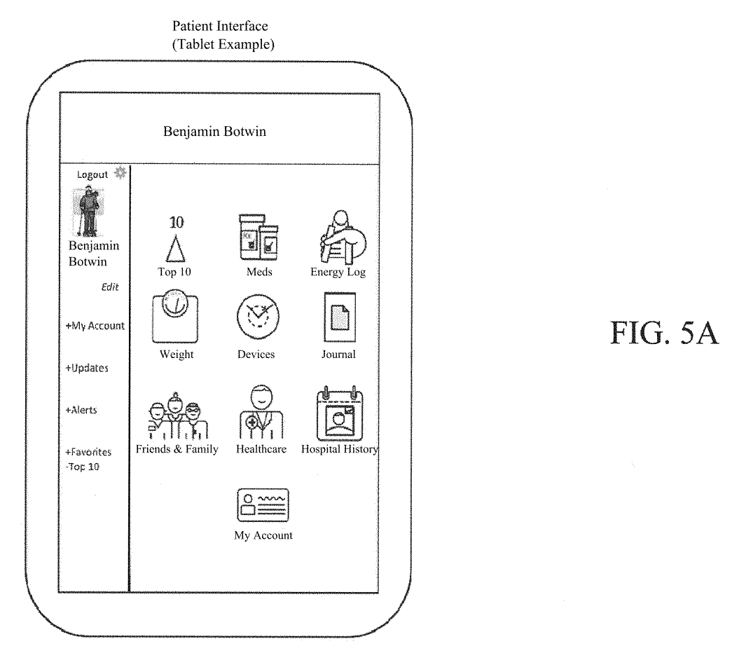

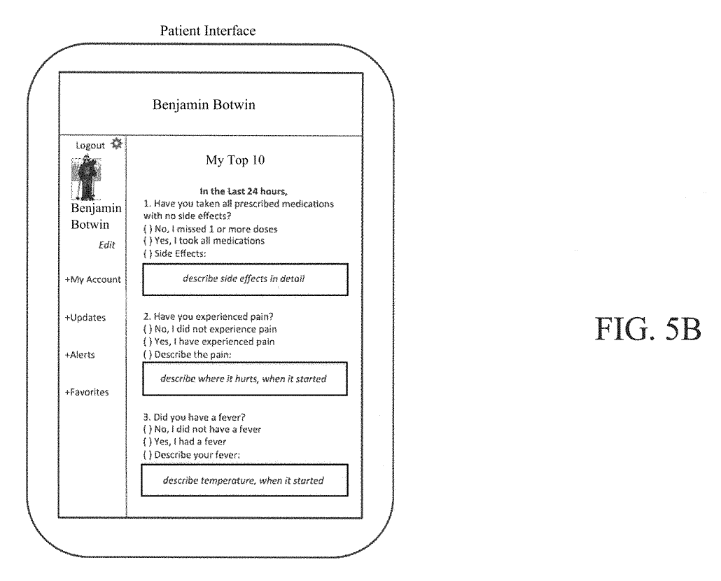

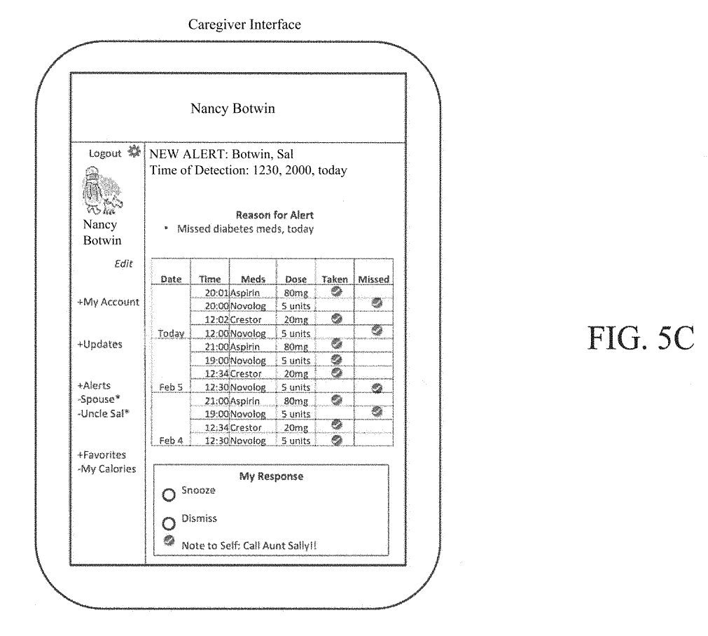

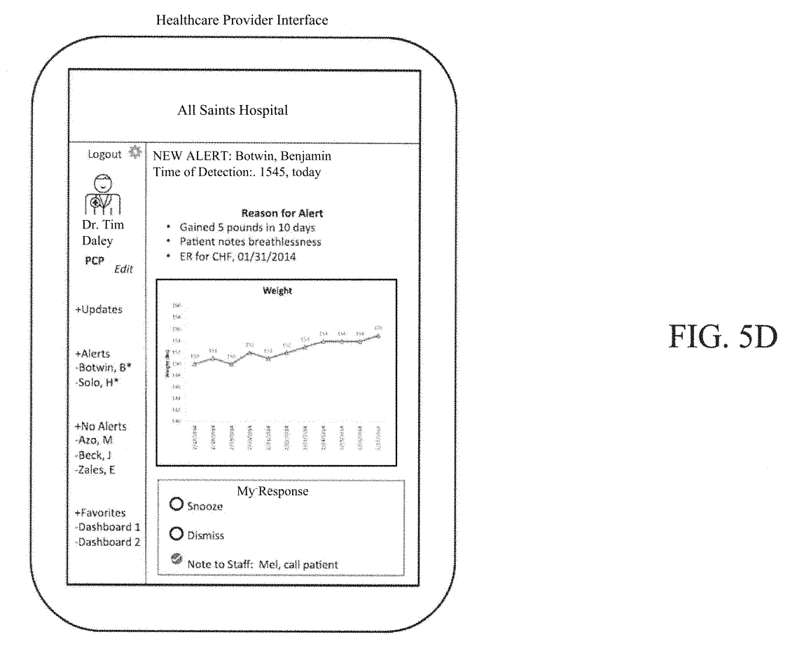

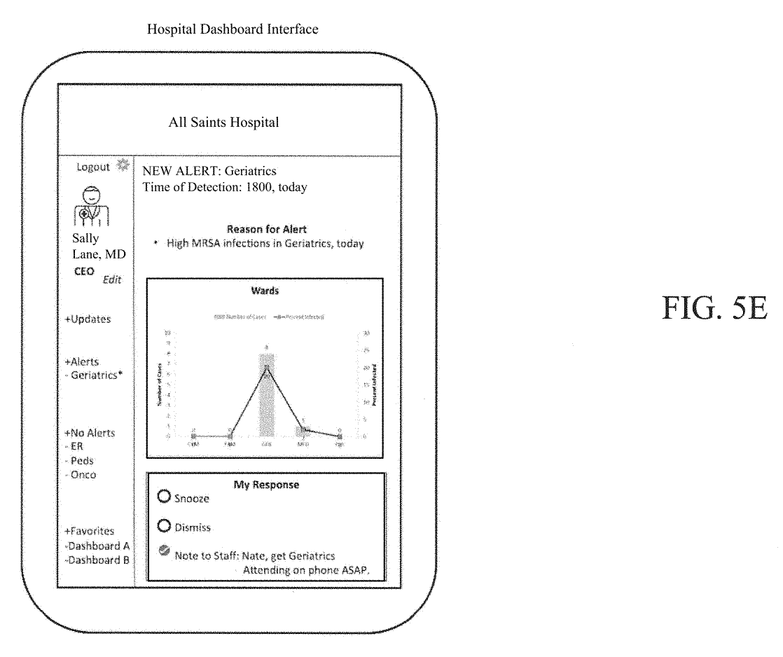

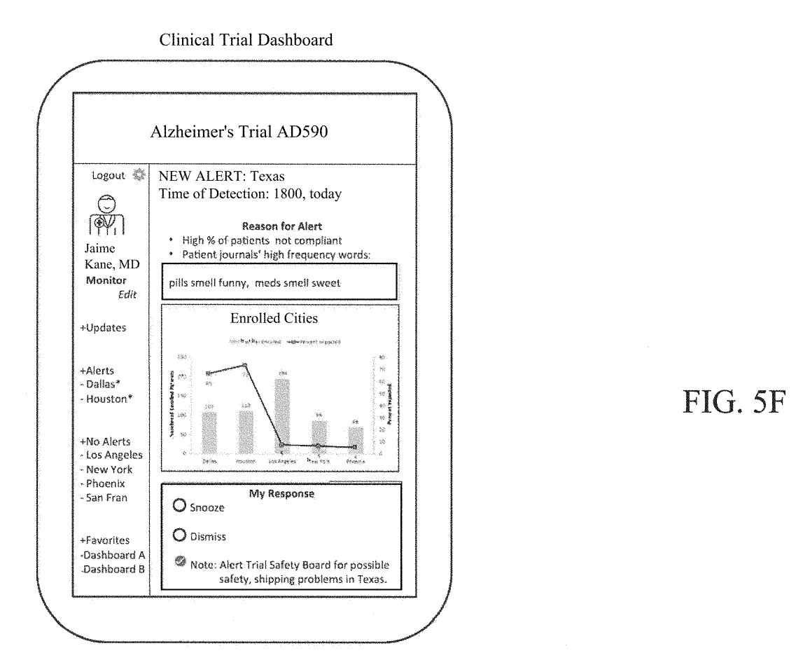

FIGS. 5A-5F show a series of screenshots from an exemplary implementation at one of the computer-based user interface devices.

More particularly, FIG. 5A shows one example of a user interface on a tablet, which is a typical computer-based user interface device. The “Top 10” icon in this example leads to a series of ten health-related questions that can be answered on a periodic basis (e.g., on a daily basis) and communicated to the computer-based processing system 106. FIG. 5B shows an example of three such questions, that ask the patient whether they have taken all of their medications and whether they are experiencing any side effects, about any pain they may be feeling, and about any fever they may be experiencing. Such data can be analyzed alongside other monitoring data to gain deeper insight into patient conditions during analytical evaluation by the computer-based processing system 106. Other icons in FIG. 5A include the “Meds” or medications interface, which allows a patient or healthcare professional to enter a schedule for taking medications, prompts the patient to take the scheduled medications at the appropriate times, and uploads compliance information to the computer-based processing system 106. The “Energy Log” accepts patient input regarding how energetic they are currently feeling, which can be accessed periodically, such as once a day, and the results uploaded to the computer-based processing system 106. The “Energy Log” interface also displays the past and current energy levels reported by the patient. The “Weight” icon allows input of current weight information from the patient and communicates with the computer-based processing system 106, as well as displays past and current weight information. The “Devices” interface accepts input from personal monitoring devices, such as a heart monitor, communicates personal monitoring information with the computer-based processing system 106, as well as displays past and current personal monitoring information. The “Journal” interface provides a mechanism for the patient to enter and display personal medical information and notes, and to communicate this information with the computer-based processing system 106. The “Friends & Family” interface provides a mechanism for the patient to allow other caregivers (e.g., friends and family members) access to some of their personal medical information and the notifications generated by the system. The “Healthcare” interface provides a mechanism whereby the patient may list healthcare professional and insurance company contact information and policies numbers, and communicate this information to the computer-based processing system 106. The “Hospital History” interface provides a mechanism to enter and display information of hospital stays and other relevant medical information. The “My Account” interface provides a mechanism for entering personal information and settings.

FIG. 5C shows an example of a Caregiver Interface. The caregiver receives an alert when one of the patients supervised by the caregiver misses their medication, so the caregiver can intervene to produce improved health outcomes. The display also shows the recent history of medication compliance for the supervised patient and allows the caregiver to make a note of how to respond to the situation. Additionally the caregiver can choose to dismiss the alert, indicating that it has been responded to, or to have it appear again later, when the caregiver may be less busy and can respond to it (effected by selecting the “snooze” option).

FIG. 5D shows an example Healthcare Provider Interface. The doctor in this case is receiving an alert because a particular patient has a series of indications that together suggest a problem, including recent weight gain, patient-reported shortness of breath, and recent history of congestive heart failure. The display shows the recent weight gain, all communicated by the computer-based processing system 106. The interface also allows the healthcare provider to make a note of how to respond to the situation, to dismiss the alert, or to snooze the alert.

FIG. 5E shows an example Hospital Staff Interface. The computer-based processing system monitors data reported to it from across the hospital and its analytics report a large incidence of MRSA cases in a particular ward today (e.g., the geriatrics ward). The interface shows a comparison of numbers of MRSA cases and MRSA rates among different wards in the hospital. The interface allows the staff member to make a note of how to respond to the situation, to dismiss the alert, or to snooze the alert.

FIG. 5F shows an example Clinical Trial Interface, used by a staff member monitoring a clinical trial. The staff member is receiving an alert because a large number of patients are not taking the trial medication and their journals show common language suggesting that there is something wrong with a particular batch of medication delivered to Dallas and Houston but not to Los Angeles, New York, or Phoenix. Relevant data for analyzing the situation is displayed on the screen, such as enrollment numbers and compliance rates by city. The staff member can respond to the alert by snoozing it, dismissing it, or making a note of how to respond to the situation.

### Hypothetical Use Cases

What follows are two hypothetical use cases, each of which includes an example of how implementations of the systems described herein may be used to efficiently allocate medical expertise and/or resources (medical or otherwise).

### Case 1: Clinical Trial

A company is engaged in a clinical trial to assess the effect of a new Alzheimer's drug. The company knows that the drug works on only a subset of the population, but they have been unable to this point to ascertain how to identify patients who respond positively. Nevertheless, in order to recoup the investment on their research, they initiated a large-scale clinical trial. Each trial participant, whether in the placebo or treatment group, began the trial with a genome analysis and blood chemistry test; every month during the trial the blood chemistry test is repeated. Because the company does not know which patients will respond to treatment, or even what fraction, they are concerned that the trial might not be large enough to show statistical significance. If they need to wait until the end of the trial only to learn that it is not working, they would lose their original research investment.

The company uses the system to monitor all data in the trial. All genetic and blood tests are downloaded from medical records into the computer-based processing system. Patients use a computer-based application that both reminds them when to take a dose and asks them to enter when they actually took the dose; by inference, missed doses are detected and transmitted to the computer-based processing system. The system is able to observe early on a subset of the patients, who are likely strong responders, and to identify a combination of genetic and blood chemistry biomarkers for the responding participants. Moreover, from the blood chemistry analysis, the system can flag patients who are non-compliant, and they can be removed from the trial. Human trial monitors access the system analysis through a special portal that maintains patient confidentiality and the double-blind nature of the trial, yet permits a window into the analysis and properly anonymized and blinded versions of the data.

The system's analysis further confirms that the size of the trial is insufficient to guarantee statistical significance. A new arm is added to the trial mid-stream, but in this arm patients are prescreened for the genetic and blood biomarkers that the system identified as being predictive of good responders. The new arm is relatively small (and thus inexpensive), and shows strong results in a short period of time, resulting in more rapid approval and larger profits under the remaining patent period associated with drug in question.

### Case 2: Congestive Heart Failure Risk Analysis

Angela is an 82-year old woman with congestive heart failure. Most of the time she is fine, but every once in a while her medications, diet, and exercise are out of balance, and she experiences fluid buildup. This results in difficulty breathing, an ambulance run to the emergency room, and being admitted to the hospital for a few days to re-establish her steady state. Hypothetically, she is one of thousands of patients in a particular health care system (e.g., one that includes multiple hospitals) in the same situation, and these incidents are more frequently being flagged and under-reimbursed by health insurance systems. The health care system would like to find a solution to identify these patients before they have an episode, have them seen in an office visit or even have a visiting nurse see them, and rebalance their diet and medication before there is an event requiring hospitalization.

The health care system uses the system to monitor and manage its entire congestive heart failure cohort. Each patient receives a FitBit™ activity and exercise monitor that uses Bluetooth™ technology and the Internet to upload data to FitBit's servers; the patient also records their daily weight in the FitBit™ application. Each patient is further instructed on how to report on their dietary intake using the MyFitnessPal™ application. The system extracts daily data from the FitBit™ and MyFitnessPal™ databases for each patient and securely transfers the data to its own servers where it resides in encrypted form. The system's computational infrastructure parameterizes a diet-exercise-weight model for each patient. The model takes as input what the person has eaten (diet) and their level of activity (exercise), and predicts what their weight should be, assuming no fluid buildup. By comparing predicted to actual weight, the system flags patients who are likely to be experiencing weight gain due to fluid buildup, and sends a notification to the health care system so individual follow up can be arranged. Additionally, medical personnel can access the system and examine a list of patients assessed as being at high risk for fluid buildup, allowing medical personnel to implement a triage-like protocol to allocate resources to the most appropriate patients. The resulting reduction in emergency room visits and hospital stays that are insufficiently reimbursed by insurance reflects well on the bottom line.

A number of embodiments have been described. Nevertheless, it will be understood that various modifications may be made without departing from the spirit and scope of the present disclosure.

For example, a system, as disclosed herein, may be used substantially simultaneously to monitor and process data associated with multiple different groups of individuals, with the individuals in each respective group having experienced or experiencing some particular health-related experience. The processing and other functionalities associated with the different groups may be implemented, for example, sequentially or in parallel.

In some implementations, the system stores (e.g., in a database) information about treatments, conditions, and/or outcomes are associated with different individuals. In some implementations, the system is adapted to identify, with a generated notification, which treatment or type of treatment may be most likely to lead to improved health of an individual identified with the generated notification. The system output, including, for example, information about treatments, conditions, and outcomes, may be reported to a patient, a health care professional, a physician, a case manager, a mental health professional, a care giver, a family member, or another individual.

The system may be adapted to report results (e.g., generated notification) via text message, via electronic mail message, via a web page or other computer interface, via electronic communication, via pager, and/or via telephone call. In some implementations, some or all of the system communications are secure. In some implementations, security is provided using encryption via SSL, via a public key encryption system, and/or via a shared key encryption system to secure communications between the computer-based processing system and the computer-based user interface devices.

In some implementations, data may be stored in encrypted form. Additionally, in some implementations, data can be accessed and output can be reported in de-identified form. In some implementations, the system logs every occasion and every user that has accessed each record and/or item of data.

In some implementations, the system is adapted to flag when a particular individual has participated in one or more past clinical trials. In some implementations, the system identifies whether that individual was a good participant in the past clinical trials.

In various embodiments, the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially-generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to include a propagated signal, a computer storage medium may be a source or destination of computer program instructions encoded in an artificially-generated propagated signal. The computer storage medium can also be, or be included in, one or more separate physical components or media, for example, multiple CDs, computer disks, and/or other storage devices.

The operations described in this specification can be implemented as operations performed by a data processing apparatus (e.g., a processor) on data stored on one or more computer-readable storage devices or received from other sources. The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein as occurring in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, some of the concepts disclosed herein can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The phrase computer-readable medium or computer-readable storage medium is intended to include all mediums that are statutory (e.g., in the United States, under 35 U.S.C. §101), and, in some instances, to specifically exclude all mediums that are non-statutory in nature to the extent that the exclusion is necessary for a claim that includes the computer-readable (storage) medium to be valid.

Other implementations are within the scope of the claims.

What is claimed is:

1. A computer-based method comprising:
receiving health-related data at a computer-based processing system, via a network, wherein the health-related data is associated with each respective one of a plurality of individuals participating in a computer trial;
applying an artificial intelligence-based evaluation of each of the patients, based on the health-related data, to identify patients for whom participation in the clinical trial should be altered;
generating a notification that, when rendered at a computer-based user interface device, reveals the identified information;
receiving feedback at the computer-based processing system, via the network, that corresponds to the generated notification, after the clinical trial participation is altered; and
adjusting the artificial intelligence based evaluation at the computer-based processing system in view of the feedback received to improve the computer-based processing system's ability to accurately identify patients for whom participation in the clinical trial should be altered.

2. The computer-based method of claim 1, wherein identifying patients for whom participation in the clinical trial should be altered comprises identifying patients that are being non-compliant with respect to participation in the clinical trial.

3. The computer-based method of claim 1, wherein identifying patients for whom participation in the clinical trial should be altered comprises identifying patients experiencing adverse reactions to the clinical trial.

4. The computer-based method of claim 1, wherein identifying patients for whom participation in the clinical trial should be altered comprises identifying patients that have a high likelihood of being strong responders to the clinical trial.

5. The computer-based method of claim 1, wherein identifying patients comprises:
calculating, based on the health-related data received, how likely each respective individual in the group is to possess a particular characteristic;
ranking the individuals according to the calculated likelihoods.

6. The computer-based method of claim 1, wherein identifying patients comprises identifying one or more of the individuals in the group that are at highest risk for possessing a particular characteristic.

7. The computer-based method of claim 1, wherein the feedback received for each respective individual comes from one or more of the following sources:
an electronic database with medical records for that individual, which have been entered by or on behalf of a licensed medical practitioner associated with that individual;
data that relates to that individual's health and was entered by or on behalf of that individual, via one of the computer-based user interface devices; and
one of the computer-based user interface devices embodying a computer-based health-monitoring device associated with that individual.

8. The computer-based method of claim 1, further comprising:
enabling access to a rendered version of the generated notification at one or more of the computer-based user interface devices.

9. The computer-based method of claim 8, further comprising:
restricting access to the rendered version of the generated notification to only the individual associated with the generated notification and/or any one or more other parties that the associated individual has authorized to access the rendered version of the generated notification.
